(19) United States
(12) Patent Application Publication
(10) Pub. No.: US 2021/0201394 A1
(43) Pub. Date: Jul. 1, 2021

(54) DYNAMIC FINANCIAL HEALTH PREDICTOR

(71) Applicant: LendingClub Corporation, San Francisco, CA (US)

(72) Inventors: Steve Lemanski, San Francisco, CA (US); Michelle McCarthy, San Francisco, CA (US); Alex Karaman, Oakland, CA (US)

(21) Appl. No.: 16/729,242

(22) Filed: Dec. 27, 2019

(51) Int. Cl. G06Q 40/02; G06F 16/28; G06N 5/04

(52) U.S. Cl. CPC G06Q 40/02; G06N 5/04; G06F 16/285

(57) ABSTRACT

Techniques are described herein for dynamic financial health prediction. In an embodiment, device application data that includes a plurality of data records relating to one or more software applications installed on a user computing device is collected and stored. A plurality of financial health scores is generated for a user account based at least in part on the plurality of data records relating to the one or more software applications installed on a user computing device. A correlation is identified between values from the one or more data record of the plurality of data records and the plurality of financial health scores of the user account. If the correlation satisfies one or more criteria, an action to be executed on the user computing device.

### FIELD OF THE INVENTION

The technical field to which the present disclosure generally relates is computer software in the field of financial data analysis. The technical field also relates to techniques for calculating metrics that represent financial health based on application specific data, for use as a foundation in taking computer-implemented actions.

### BACKGROUND

Understanding where an individual person stands financially is important to the financial health of the individual. The accuracy of an individual's financial health score is dependent on various pieces of data associated with the individual. However, data that is key to the accuracy of a financial health score is often highly sensitive and difficult to obtain, resulting in inaccurate assessments of financial health.

Inaccurate assessments of financial health can lead to individuals taking efforts to increase their financial health that are not always in their best interest. Additionally, even if an individual is aware of their financial health, they often feel powerless to improve it or fail to take corrective action.

Thus, techniques are desired to more accurately predict financial health and provide corrective financial health computer-implemented actions based on financial health.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram illustrating a system for dynamic financial health prediction, according to an embodiment.

FIG. 2 is a flowchart illustrating steps for dynamic financial health prediction, according to an embodiment.

FIG. 3 is a block diagram of a computer system that may be used to implement the techniques described herein.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system for dynamically generating financial health predictions (a “dynamic financial health predictor”) is described herein. “Device application data” that is associated with software applications installed on a user computing device, such as a mobile phone, can be retrieved and organized into data records. Such device application data may include, for example may include any information retrieved or associated with a software application installed on user computing device. Each data record can be associated with a software application ID that can identify, for example, a software application installed on the user computing device from which the respective data record is obtained. For example, a data record containing a value for an amount of time a user spent on an ‘Amazon’ software application over a 1 month span may be associated with a software application ID 9999, where the software application ID identifies the ‘Amazon’ software application.

The device application data can be combined with other external data and assigned into categories which may include: financial account data, emotional feedback data, and behavioral data. Each category may be weighted and used to a generate a financial health score for a user account. A financial health score indicates a financial health of a user account at a distinct point in time. For example, a financial health score generated in December for a user account may be 90/100, indicating a strong financial health of the user account.

Multiple financial health scores can be generated for a user account over a period of time. The multiple financial health scores can then be compared to device application data record values to identify correlations between data record values and the financial health scores of the user account. When a correlation that is identified between a particular data record value and financial health scores satisfies specific criteria, such as being identified as a particularly strong correlation, instructions are generated that cause an action to occur on the user computing device. The instructions are transmitted to the user computer device and executed by the user computer device.

For example, a strong correlation between an amount of time spent on an ‘Amazon’ software application and the financial health scores of a user account may be identified. The correlation may indicate that as more time is spent on the ‘Amazon’ software application, financial health of the user tends to decrease. In this scenario, instructions that cause the user computing device to restrict access to the ‘Amazon’ software application may be generated and transmitted to the user computing device. By the user computing device restricting access to the ‘Amazon’ software application, the financial health score of the user account will increase over time.

### Device Application Data

Device application data may include any information relating to one or more software applications 104-108 installed on a user computing device 102. For example, device application data may include any information retrieved from an API associated with a software application 102-108 installed on user computing device 102. Device application data may also include any information retrieved from an API associated with the operating system 110 of user computing device 102 such as log data that specify how often each software application is accessed and durations of time that each software application is accessed.

Device application data may be organized into data records where each data record represents a selection of device application data. Each data record may identify a software application that is associated with the respective data record. For example, a data record that specifies an amount of time spent by a user on a particular software application may include a reference to an application identification (ID) of the particular software application.

Device application data may be processed by server computer and categorized into different categories of data, such as financial account data, emotional feedback data, behavioral data, and/or environmental data, as further discussed herein.

### Financial Account Data

Financial account data refers to information relating to a financial account. Selections of device application data records may be categorized as financial account data associated a user account. For example, device application data records may identify, for a particular software application installed on a user computing device, one or more financial transactions that were performed using the particular software application and group each financial transaction into a separate data record. Additionally, or alternatively, financial account data may be retrieved from third party sources, retrieved manually from a consumer using user computing device 102, and/or any combination thereof. Financial account data may be stored in database.

Financial account data may include, for example, a balance of a financial account; a credit limit of the financial account; reward information associated with the financial account; account holder information on file with a financial institution including names, emails, phone numbers, and addresses; income information associated with the financial account; liability information including any recurring payments associated with the financial account, any loans associated with the financial account, an amount owed for any existing loan, loan terms for any existing loans, and original loan amount; and one or more financial transactions associated with the financial account that each include: a date, a merchant name or transaction description, location, category, and amount.

### Emotional Feedback Data

Emotional feedback data refers to any information relating to an emotional state of a user associated with a user account. Selections of device application data records may be categorized as emotional feedback data associated a user. For example, device application data records may identify, for a particular software application installed on a user computing device, one or more social media statuses that were posted using the particular software application that may indicate an emotional state of the user. Additionally, or alternatively, emotional feedback data may be retrieved from third party sources, retrieved manually from a consumer using user computing device 102, and/or any combination thereof. Emotional feedback data may be stored in database 114.

In one embodiment, emotional feedback data is retrieved directly from user computing device 102. For example, user computing device 102 may include an interface that allows a user to provide emotional feedback information regarding the current state of the user's financial health. For example, a user may provide feedback that, on a given day, the user feels great about their current financial health. As another example, a user may provide feedback that, on a given day, the user feels 8/10 about their current financial health.

### Behavioral Data

Behavioral data refers to information relating to the behavior or actions of a user associated with a user account. Selections of device application data records may be categorized as behavioral data associated with a user account. For example, device application data records may identify, for a particular software application installed on a user computing device, a search history of search phrases entered by a user. In another example, device application data records may identify, for a particular software application installed on a user computing device, an amount of time spent by a user on a particular software application over a period of time. Additionally, or alternatively, behavioral data may be retrieved from third party sources, retrieved manually from a consumer using user computing device 120, and/or any combination thereof. Behavioral data may be stored in database.

### System Overview

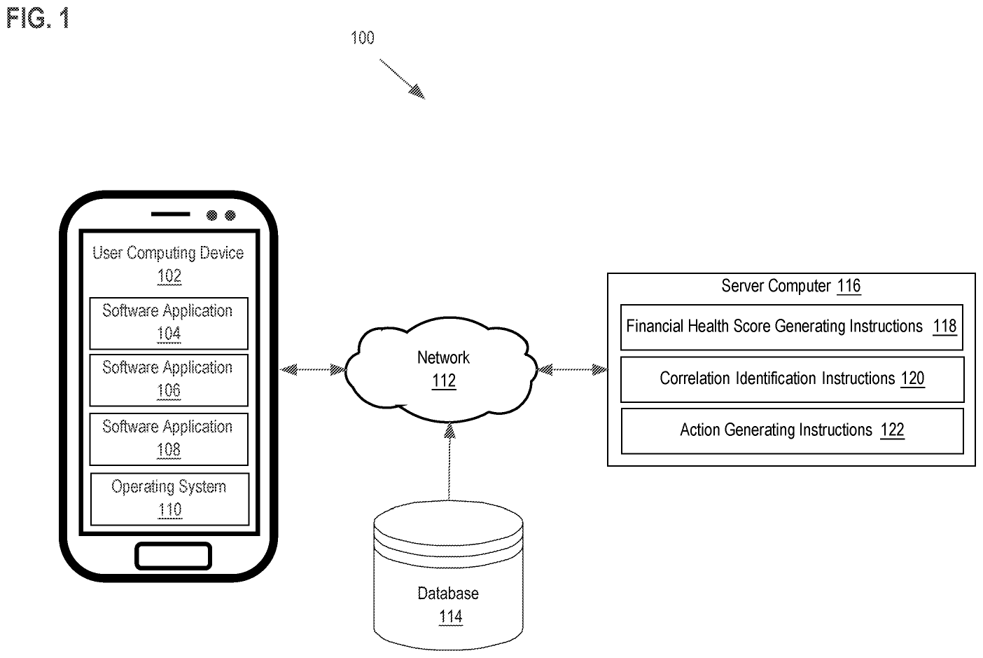

FIG. 1 illustrates an example networked computer system with which various implementations may be practiced. FIG. 1 is shown in simplified, schematic format for purposes of illustrating a clear example and other implementations may include more, fewer, or different elements. System 100 comprises various entities and devices which may be used to practice an implementation. Network 112 is a network entity which facilitates communication between entities depicted in FIG. 1. Connection to network 112 is show by double-sided arrows between a connecting entity and network 112. Network 112 may be any electronic communication medium or hub which facilitates communications between two or more entities, including but not limited to an internet, an intranet, a local area connection, a cloud-based connection, a wireless connection, a radio connection, a physical electronic bus, or any other medium over which digital and electronic information may be sent and received.

Server computer 116 is connected to network 116 and is an entity which allows the generation of financial health scores, the identification of correlations that exist between selections of data records and financial health scores, and the generation and transmission of actions to be executed on user computing device 102. Server computer 116 may be any hardware, software, virtual machine, or general-purpose entity capable of performing the processes discussed herein. In various implementations, the server computer 116 executes financial health score generating instructions, correlation identification instructions, and action generating instructions, the functions of which are described in other sections herein. The server computer 116 may also execute additional code, such as code for generating and transmitting requests to user computing device and database.

The financial health score generating instructions 118 may be programmed or configured to generate a financial health score for a user account. For example, the health financial score generating instructions 118 may include features to access information from the database 114 and/or user computing device 102. The financial health score generating instructions 118 may also access external data sources and transmit or receive data to and from the correlation identification instructions 120. The financial health score generating instructions 118 may also be used for implementing aspects of the flow diagrams that are further described herein.

The correlation identification instructions 120 may be programmed or configured to identify correlations between selections of data record values and financial health scores. For example, the correlation identification instructions 120 may include features to access data from the database 114 and/or user computing device. The correlation identification instructions 120 may also access external data sources and transmit or receive data to and from the financial health score generating instructions 118. The correlation identification instructions 120 may also be used for implementing aspects of the flow diagrams that are further described herein.

The action generating instructions 122 may be programmed or configured to generate actions for execution by the user computing device 102. The action generating may generate instructions, requests, notifications, and/or recommendations to transmit to a user computing device 102 for execution or display. For example, the correlation identification instructions 120 may include features to access data from the database 114 and/or user computing device 102. The correlation identification instructions 120 may also access external data sources and transmit or receive data to and from the financial health score generating instructions 118. The correlation identification instructions 120 may also be used for implementing aspects of the flow diagrams that are further described herein.

Computer executable instructions described herein may be in machine executable code in the instruction set of a CPU and may have been compiled based upon source code written in JAVA, C, C++, OBJECTIVE-C, or any other human-readable programming language or environment, alone or in combination with scripts in JAVASCRIPT, other scripting languages and other programming source text. In another embodiment, the programmed instructions also may represent one or more files or projects of source code that are digitally stored in a mass storage device such as non-volatile RAM or disk storage, in the systems of FIG. 1 or a separate repository system, which when compiled or interpreted cause generating executable instructions which when executed cause the computer to perform the functions or operations that are described herein with reference to those instructions. In other words, the drawing figure may represent the manner in which programmers or software developers organize and arrange source code for later compilation into an executable, or interpretation into bytecode or the equivalent, for execution by the server computer 116.

User computing device 102 is a user account device/entity which allows an individual user to interact with software applications 104-108 installed on the user computing device 102. User computing device 102 may be any device, such as a mobile computing device, capable of connection to network 102 through any method described herein. User computing device 102 may comprise various programs, modules, or software applications, including operating system and software applications 104-108. The user computing device may receive actions comprising instructions, requests, notifications, and/or recommendations to execute or display from server computer 116.

In various implementations, a particular application may be programmed or configured to query for and retrieve device application data from application programming interfaces (APIs) associated with various software applications 104-108 installed on user computing device 102. In one embodiment, the operating system 110 is configured to provide discoverability features to the particular software application. Discoverability features may include a list of API endpoints for each software application 104-108 installed on user computer device 102 that can be used to retrieve application specific data from each respective software application. The particular software application may also be configured to query for and retrieve device application data from APIs associated with the operating system 110 of user computing device 102. The particular software application may be configured to store the retrieved device application data in database for further processing.

In other embodiments, code or instructions that is executing external to user computing device 102, such as code executed by server computer 116, may be programmed or configured to query for and retrieve device application data from APIs associated with software applications 102-108 installed on user computing device and/or the operating system of the user computing device.

Database 112 may be any number of individual or linked storage devices or mediums which allow the storage of digital data related to the generation of a financial health score. For example, database 112 may store device application data for a plurality of applications. Database 112 may also store device application data, financial account data, emotional feedback data, behavioral data, and any other data used to generate a financial health score for a user account, as discussed herein.

### Financial Health Scores

A financial health score can be generated that indicates a financial health of a user account. A financial health score may be generated based on any combination of financial account data, emotional feedback data, behavioral data, and other data, such as environmental data. Specifically, one or more metrics can be derived for each type of data and used to generate a financial health score.

Financial account metrics can be generated based on financial account data. Financial account metrics may comprise different financial features and corresponding values. For example, various financial features may include: debt level, revolving debt level, income, savings, spending, expenses, budget deviation, assets, investments, credit score, credit utilization. Some financial features and corresponding values may be provided directly by financial account data without any processing. In other cases, financial account data can be processed to determine the values of financial features. For example, to determine a value for a ‘budget deviation’ feature, a budget amount from the financial account data can be compared to a total amount spent over a period of time to provide a value for budget deviation over a period of time.

As another example, a debt level feature may indicate on a scale of 1-10 an amount of debt. A score of 10 may indicate that a user account has a debt level of $25,000 or more while a score of 5 may indicate that the user account has a debt level between $10,000 and $12,500.

A credit score feature may indicate on a scale of 1-10 a relative credit score of a user account. A score of 10 may indicate that a user account has a credit score greater than 780 while a score of 5 may indicate that the user account has a credit score between 670 and 699.

A savings feature may indicate on a scale of 1-10 an amount of savings of a user account. A score of 10 may indicate that a user account has a savings amount greater than $25,000 while a score of 5 may indicate that the user account has a savings amount of $1,500.

An income/spending feature may indicate on a scale of 1-10 a cash flow metric for an amount of time. A score of 10 may indicate that a user account has a positive cash flow for 5 consecutive months while a score of 5 may indicate that the user account has negative cash flow for 1 month.

Similar to financial account metrics, emotional feedback metrics can be generated based on emotional feedback data. Emotional feedback metrics may comprise different emotional features and corresponding values. For example, emotional features may include: financial health sentiment, social media sentiment. Some emotional features and corresponding values may be provided directly by emotional feedback data without any processing. For example, as discussed previously, emotional feedback data may be gathered through an interface that prompts a user to enter on a scale of 1-10 how the user feels about their current financial health. The value entered by the user can be used as the value for a ‘financial health sentiment’ feature.

In other cases, emotional feedback data can be processed to determine the values of emotional features. For example, to determine a value for a ‘social media sentiment’ feature, one or more social media statuses retrieved some various social media software applications can be analyzed using various natural language processing (NLP) techniques such as sentiment analysis to assign a value from 1-10 to each status, where 1 indicates a most negative sentiment and 10 indicates a most positive sentiment. One or more status values that occur within a period of time can be averaged to generate a single status value for a period of time. The single status value can be used as the value for a ‘social media sentiment’ feature.

Similar to financial account metrics and emotional feedback metrics, behavioral metrics can be generated based on behavioral data. Behavioral metrics may comprise different behavioral features and corresponding values. For example, behavioral features may include: search engine optimism, purchasing propensity, purchasing frequency. Some behavioral features and corresponding values may be provided directly by behavioral data without any processing. In other cases, behavioral data can be processed to determine the values of behavioral features. For example, to determine a value for a search history optimism feature, multiple search terms retrieved from various search engine software applications can be scanned for specific keywords or phrases that are indicative of an optimistic attitude toward financial health. Search terms for “inheritance tax” may indicate that a user has received or is about to receive an inheritance and thus is highly optimistic about financial health. Search terms for “how to get out of debt” may indicate that a user is in debt and thus is pessimistic about financial health. The identifying of specific terms from search histories can result in assigning a value from 1-10 to the search history optimism feature, where a value of 10 indicates that a user is highly optimistic regarding their financial health and 1 indicates that a user is highly pessimistic, based on their search terms, regarding their financial health.

In another example, to determine a value for a purchasing propensity feature, behavioral data that indicates how much time a user spent using a particular shopping software application can be compared to an amount of time the user spent using non-shopping software applications can be used to generate a value from 1-10 for the purchasing propensity feature, where a value of 1 indicates that the user spent little to no time on their device using the particular shopping software application and a value of 10 indicates that the user spent nearly all their time on their device using the particular shopping software application.

A feature may be associated with one or more software application IDs that indicate an origin of the data that the respective feature is dependent on. For example, as discussed previously, when device application data is retrieved, each data record included in the device application data is associated with an application ID. Each data record maintains the application ID association as each respective data record is categorized into different data categories such as financial account data, emotional feedback data, and behavioral data. As data records are processed to generate values for various features, the application IDs associated with each respective data record are then associated with each feature. As an example, a purchasing propensity feature value may be generated based on data records associated with a particular shopping application such as ‘Amazon’. Thus, the purchasing propensity feature will be associated with an application ID corresponding to the ‘Amazon’ application.

Metrics discussed above may be normalized using min-max scaling techniques to ensure data is all scaled to the same level. Outlier removal techniques may also be performed on the data to remove data records that are anomalies.

Once the metrics are normalized, features and corresponding values associated with the metrics can be combined to generate a financial health score. Each feature may be assigned different weights depending on how much influence each respective feature should have on the financial health score. For example, a ‘debt level’ feature may be assigned a substantial weight while a ‘purchasing propensity’ feature may have a slight weight.

As an example, a financial health score with weighting can be calculated according to the following formula: Financial health score=w1*feature1+w2*feature2+w3*feature3+ etc.

### Financial Health Score Correlations

Correlations can be identified based on device application data and financial health scores. Correlations can also be identified based on various financial, emotional, and/or behavioral features and financial health scores. For example, server computer 116 may execute correlation identification instructions 120 to calculate a correlation coefficient that identifies a strength of a correlation between one or more data record values from the device application data and a set of financial health scores associated with a user account. As another example, server computer 116 may execute correlation identification instructions 120 to calculate a correlation coefficient that identifies a strength of a correlation between a set of features and a set of financial health scores associated with a user account.

Correlation coefficients may be calculated using various techniques. One technique includes calculating a Pearson correlation coefficient between two variables. Correlations between two variables are viewed in accordance with correlation vectors, paired as x and y and expressed as (x,y), for example, as (x1, y1), (x2, y2), (x3, y3), as indicated at the matrix. This correlation is represented by the correlation coefficient “c”. The correlation coefficient “c” is also known and referred to herein as a Pearson's Correlation Coefficient. The correlation coefficient “c” is a measure of the correlation among two vectors, x and y. The correlation coefficient is expressed as: r=cov (x,y)/σ(x)σ(y), where, cov (x,y) is a correlation vector of one variable x to another variable y; σ(x) is a vector representative of a set of data record values from device application data or a set of values for a feature; σ(y) is a vector representative of a set of financial health scores of a user account. Each set of data record values, feature values, and financial health scores may include multiple values from distinct points in time.

The equation will yield a value of “r”, the correlation coefficient, ranging from −1 to 1. A positive value of the correlation coefficient “r” typically indicates a positive correlation between the two variables. Here for example, correlation coefficients “r” are determined for the correlation of one or more data records from device application data and financial health scores of a user account, or values of features and financial health scores of a user account. Typically, the closer the correlation coefficient (r) is to “1” or “4”, the greater the correlation between the two variables being analyzed.

In other embodiments, various techniques can be used to calculate and identify a metric of correlation between two variables, including Spearman's rank correlation coefficient.

### Actions Based on Correlations

Once correlations between variables are identified, the correlation coefficients can be evaluated against one or more criteria to determine whether an action should be executed. The one or more criteria used to evaluate correlations may include criteria that specifies a threshold value for correlation coefficients. For example, a correlation coefficient may be required to be greater than a threshold value of 0.8 for an action to be executed.

The server computer 116 may execute action generating instructions 122 to evaluate correlations against specified criteria and generate various instructions, requests, notifications, and/or recommendations to transmit to a user computing device 102 for execution or display. Action generating instructions 122 may generate: a request to restrict access to one of more software applications, a request to uninstall one or more software applications, a request to install a new software application, a recommendation to restrict use of one or more software applications, a recommendation to increase use of one or more software applications, a recommendation to uninstall one or more software applications, a recommendation to install one or more software applications.

Once generated, such actions may be transmitted by server computer 116 to user computing device 102. When the actions are received by user computing device 102, the user computing device 102 may execute the respective action. For example, if user computing device 102 receives a request to restrict use of one or more software applications, the operating system 110 of user computing device 102 may execute instructions to restrict a user of user computing device from using the respective software application for a specified amount of time. In another example, if user computing device 102 receives a recommendation to restrict use of one or more software applications, the operating system 110 of user computing device 102 may execute instructions to display the recommendation via graphical user interface (GUI) of the user computing device 102.

### Example Procedure

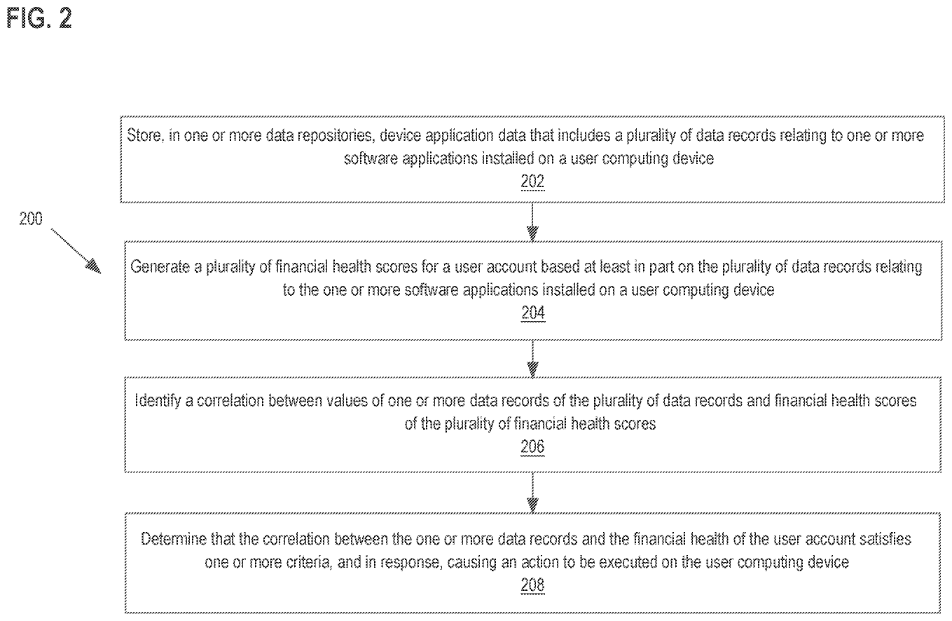

FIG. 2 depicts a method or algorithm for dynamically predicting financial health, in an example embodiment. FIG. 2 is described at the same level of detail that is ordinarily used, by persons of skill in the art to which this disclosure pertains, to communicate among themselves about algorithms, plans, or specifications for other programs in the same technical field. While the algorithm or method of FIG. 2 shows a plurality of steps, the algorithm or method described herein may be performed using any combination of one or more steps of FIG. 2 in any order, unless otherwise specified.

For purposes of illustrating a clear example, FIG. 2 is described herein in the context of FIG. 1, but the broad principles of FIG. 2 can be applied to other systems having configurations other than as shown in FIG. 1. Further, FIG. 2 and each other flow diagram herein illustrates an algorithm or plan that may be used as a basis for programming one or more of the functional modules of FIG. 1 that relate to the functions that are illustrated in the diagram, using a programming development environment or programming language that is deemed suitable for the task. Thus, FIG. 2 and each other flow diagram herein are intended as an illustration at the functional level at which skilled persons, in the art to which this disclosure pertains, communicate with one another to describe and implement algorithms using programming. The flow diagrams are not intended to illustrate every instruction, method object or sub step that would be needed to program every aspect of a working program, but are provided at the high, functional level of illustration that is normally used at the high level of skill in this art to communicate the basis of developing working programs.

At step 202, device application data that includes a plurality of data records relating to one or more software applications installed on a user computing device is stored in one or more data repositories. Each data record of the plurality of data records may identify a software application that is associated with the respective data record. For example, device application data may be retrieved from user computing device 102 by querying APIs associated with one or more software applications 104-108 installed on user computing device 102 or by querying an API associated with the operating system 110 of user computing device 102 for information relating to one or more software applications 104-108 installed on the user computer device 102.

At step 204, a plurality of financial health scores for a user account is generated based at least in part on the plurality of data records relating to the one or more software applications installed on a user computing device. Each financial health score of the plurality of financial health scores indicates a financial health of the user account at a distinct point in time.

For example, the plurality of data records relating to one or more software applications installed on a user computing device 102 may be processed by server computer 116 and categorized into financial account data, emotional feedback data, and behavioral data. Server computer 116 may perform further processing to supplement each of the financial account data, emotional feedback data, and behavioral data with additional data records that are retrieved from different sources than the user computing device. One or more metrics may be derived from each of the financial account data, emotional feedback data, and behavioral data. The one or more metrics may then be used to generate the plurality of financial health scores.

At step 206, a correlation is identified values of one or more data records of the plurality of data records and financial health scores of the plurality of financial health scores. The correlation may be identified by calculating a correlation coefficient based on the values of the one or more data records of the plurality of data records and the corresponding financial health scores of the plurality of financial health scores. The correlation coefficient indicates a strength of a relationship between the values from the one or more data records of the plurality of data records and the corresponding financial health scores of the plurality of financial health scores of the user account. In some embodiments, the correlation is between values from the one or more data records at various points in time and the corresponding financial health scores at the same various points in time.

At step 208, it is determined that the correlation between the one or more data records and the financial health of the user account satisfies one or more criteria, and in response, an action is caused to be executed on the user computing device. The one or more criteria may specify a threshold value that the strength of the relationship between the one or more data records of the plurality of data records and the financial health of the user account must satisfy for an action to be caused to be executed on the user computing device. For example, the one or more criteria may specify a threshold value that the correlation coefficient must be greater than or less than in order for the one or more criteria to be satisfied.

The action that is caused to be executed on the user computing device when the one or more criteria is satisfied may include any of: causing the user computer device to restrict access to the particular software application, causing the user computer device to uninstall the particular software application, causing the user computer device to display a recommendation regarding the particular software application.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer Systems, portable computer Systems, handheld devices, networking devices or any other device that incorporates hard-wired and/or program logic to implement the techniques.

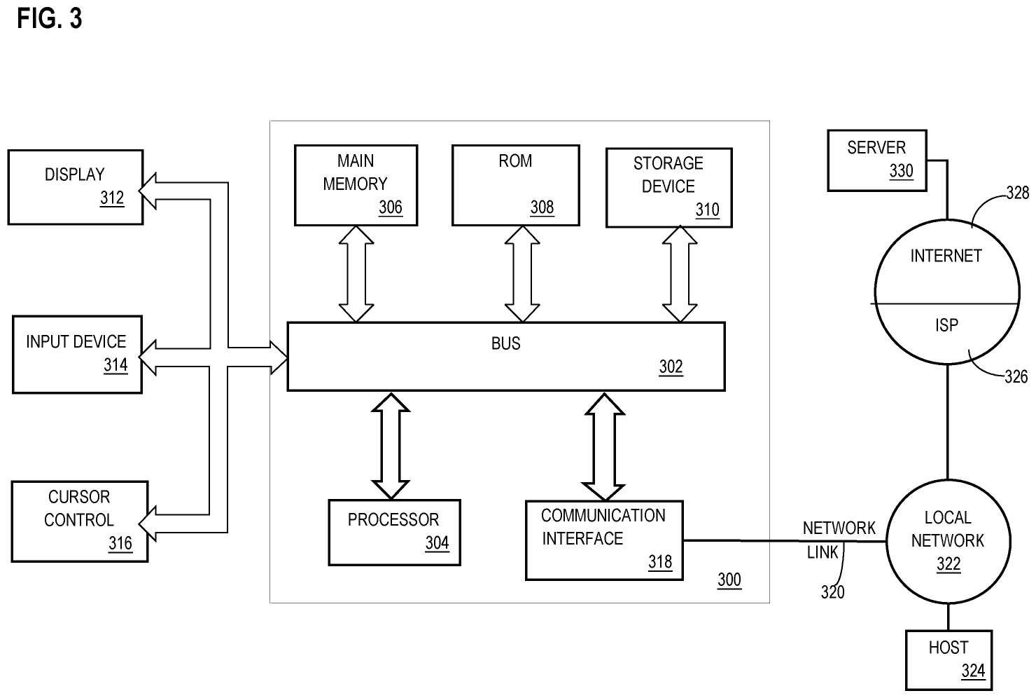

For example, FIG. 3 is a block diagram that illustrates a computer System 300 upon which an embodiment of the invention may be implemented. Computer System 300 includes a bus 302 or other communication mechanism for communicating information, and a hardware processor 304 coupled with bus 302 for processing information. Hardware processor 304 may be, for example, a general purpose microprocessor.

Computer System 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer System 300 into a special-purpose machine that is customized to perform the operations specified in the instructions.

Computer System 300 further includes a read only memory (ROM) 308 or other static storage device coupled to bus 302 for storing static information and instructions for processor 304. A storage device 310, such as a magnetic disk, optical disk, or solid-state drive is provided and coupled to bus 302 for storing information and instructions.

Computer System 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer System 300 may implement the techniques described herein using customized hard-wired logic, one or more ASICs or FPGAs, firmware and/or program logic which in combination with the computer System causes or programs computer System 300 to be a special-purpose machine. According to one embodiment, the techniques herein are performed by computer System 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 310. Volatile media includes dynamic memory, such as main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer System 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer System 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer System 300, are example forms of transmission media.

Computer System 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-implemented method comprising:
storing, in one or more data repositories, device application data that includes a plurality of data records relating to one or more software applications installed on a user computing device;
generating a plurality of financial health scores for a user account based at least in part on the plurality of data records relating to the one or more software applications installed on a user computing device;
identifying a correlation between values of one or more data records of the plurality of data records and financial health scores of the plurality of financial health scores;
determining that the correlation between the one or more data records and the financial health of the user account satisfies one or more criteria, and in response, causing an action to be executed on the user computing device.

2. The method of claim 1, further comprising:
assigning one or more categories, of a plurality of categories, to each data record of the plurality of data records;
wherein the plurality of categories includes at least financial account data, emotional feedback data, and behavioral data;
wherein each financial health score of the plurality of financial health scores is generated based at least in part on one or more metrics derived from the financial account data, emotional feedback data, and behavioral data.

3. The method of claim 2, wherein the each of the one or more metrics derived from the financial account data, emotional feedback data, and behavioral data are weighted when calculating a financial health score.

4. The method of claim 1, wherein identifying the correlation between the one or more data records of the plurality of data records and the financial health of the user account comprises:
calculating a correlation coefficient based on the one or more data records of the plurality of data records and the financial health of the user account, the correlation coefficient indicating a strength of a relationship between the values from the one or more data records of the plurality of data records and the corresponding financial health scores of the plurality of financial health scores of the user account.

5. The method of claim 4, wherein determining that the correlation between the one or more data records and the financial health of the user account satisfies one or more criteria comprises determining that the correlation coefficient satisfies a threshold value.

6. The method of claim 5, wherein the one or more data records are associated with a particular software application of the one or more software applications installed on the user computing device.

7. The method of claim 6, wherein causing an action to be executed on the user computing device comprises causing the user computer device to restrict access to the particular software application.

8. The method of claim 6, wherein causing an action to be executed on the user computing device comprises causing the user computer device to uninstall the particular software application.

9. The method of claim 6, wherein causing an action to be executed on the user computing device comprises causing the user computer device to display a recommendation regarding the particular software application.

10. The method of claim 1, wherein the correlation is between values from the one or more data records at various points in time and the corresponding financial health scores at the same various points in time.

11. One or more non-transitory computer-readable media storing instructions which, when executed by one or more processors, cause:
storing, in one or more data repositories, device application data that includes a plurality of data records relating to one or more software applications installed on a user computing device;
generating a plurality of financial health scores for a user account based at least in part on the plurality of data records relating to the one or more software applications installed on a user computing device;
identifying a correlation between values of one or more data records of the plurality of data records and financial health scores of the plurality of financial health scores;
determining that the correlation between the one or more data records and the financial health of the user account satisfies one or more criteria, and in response, causing an action to be executed on the user computing device.

12. The one or more non-transitory computer-readable media of claim 11, further comprising instructions for:
assigning one or more categories, of a plurality of categories, to each data record of the plurality of data records;
wherein the plurality of categories includes at least financial account data, emotional feedback data, and behavioral data;
wherein each financial health score of the plurality of financial health scores is generated based at least in part on one or more metrics derived from the financial account data, emotional feedback data, and behavioral data.

13. The one or more non-transitory computer-readable media of claim 12, wherein the each of the one or more metrics derived from the financial account data, emotional feedback data, and behavioral data are weighted when calculating a financial health score.

14. The one or more non-transitory computer-readable media of claim 11, wherein identifying the correlation between the one or more data records of the plurality of data records and the financial health of the user account comprises:
calculating a correlation coefficient based on the one or more data records of the plurality of data records and the financial health of the user account, the correlation coefficient indicating a strength of a relationship between the values from the one or more data records of the plurality of data records and the corresponding financial health scores of the plurality of financial health scores of the user account.

15. The one or more non-transitory computer-readable media of claim 14, wherein determining that the correlation between the one or more data records and the financial health of the user account satisfies one or more criteria comprises determining that the correlation coefficient satisfies a threshold value.

16. The one or more non-transitory computer-readable media of claim 15, wherein the one or more data records are associated with a particular software application of the one or more software applications installed on the user computing device.

17. The one or more non-transitory computer-readable media of claim 16, wherein causing an action to be executed on the user computing device comprises causing the user computer device to restrict access to the particular software application.

18. The one or more non-transitory computer-readable media of claim 16, wherein causing an action to be executed on the user computing device comprises causing the user computer device to uninstall the particular software application.

19. The one or more non-transitory computer-readable media of claim 16, wherein causing an action to be executed on the user computing device comprises causing the user computer device to display a recommendation regarding the particular software application.

20. The one or more non-transitory computer-readable media of claim 11, wherein the correlation is between values from the one or more data records at various points in time and the corresponding financial health scores at the same various points in time.
